(19) United States
(12) Patent Application Publication
(10) Pub. No.: US 2017/0373348 A1
(43) Pub. Date: Dec. 28, 2017

(54) NONAQUEOUS ELECTROLYTIC SOLUTION AND ENERGY STORAGE DEVICE USING THE SAME

(71) Applicant: UBE INDUSTRIES, LTD, Ube-shi, Yamaguchi (JP)

(72) Inventors: Koji ABE, Ube-shi (JP); Masahide KONDO, Ube-shi (JP)

(73) Assignee: UBE INDUSTRIES, LTD, Ube-shi, Yamaguchi (JP)

(21) Appl. No.: 15/539,463

(22) PCT Filed: Dec. 22, 2015
(86) PCT No.: PCT/JP2015/085761

§ 371 Date: Jun. 23, 2017

(30) Foreign Application Priority Data
Dec. 24, 2014 (JP) 2014-260837

(51) Int. Cl. H01M 10/0567; H01M 4/131; H01M 10/0568; H01M 10/0569; H01M 10/0525; H01M 4/02

(52) U.S. Cl. CPC H01M 10/0567; H01M 10/0569; H01M 10/0525; H01M 4/131; H01M 10/0568; H01M 2004/028; H01M 2300/0037

(57) ABSTRACT

There are provided: a nonaqueous electrolytic solution for an energy storage device provided with a positive electrode, a negative electrode, a separator and a nonaqueous electrolytic solution having an electrolyte salt dissolved in a nonaqueous solvent, wherein the potential of the positive electrode in a full-charge state is 4.5 V or higher on Li basis and the nonaqueous electrolytic solution contains at least one kind of tertiary carboxylic acid esters represented by the following general formula (I); and an energy storage device using the nonaqueous electrolytic solution.

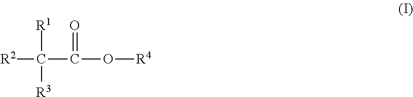

wherein R¹ to R³ each independently represent a methyl group or an ethyl group; and R⁴ represents a halogenated alkyl group having 1 to 5 carbon atoms.

### TECHNICAL FIELD

The present invention relates to a nonaqueous electrolytic solution which can be improved in electrochemical properties when an energy storage device is used at high voltages, and the energy storage device using the same.

### BACKGROUND ART

In recent years, energy storage devices, particularly lithium secondary batteries, are widely used as power sources of electronic equipment such as cellular phones and laptop computers or power sources for electric vehicles and power storage. It is highly likely that the batteries installed in such electronic equipment and vehicles are used at high temperatures in midsummer and a warm environment warmed by heat generated by the electronic equipment. Further, although for thin electronic equipment such as tablets and Ultrabooks, laminate-type batteries and square-shaped batteries in which laminate films such as aluminum laminate films are used for exterior members are used in many cases, such batteries are liable to pose such a problem that the batteries are easily deformed even with slight expansion and the like of the exterior members due to their thin shapes, and the problem is that the deformation has a very large influence on the electronic equipment.

A lithium secondary battery consists of a positive electrode and a negative electrode which contain mainly materials capable of absorbing and releasing lithium, and a nonaqueous electrolytic solution including a lithium salt and a nonaqueous solvent, and as the nonaqueous solvent, carbonates such as ethylene carbonate (EC) and propylene carbonate (PC) are used. Further, as the negative electrode of the lithium secondary battery, there are known lithium metal, metal compounds (metal elements, oxides, alloys with lithium, and the like) capable of absorbing and releasing lithium, and carbon materials. Particularly, there are widely put into practical use nonaqueous electrolytic solution secondary batteries using carbon materials such as coke and graphite (artificial graphite or natural graphite) which can absorb and release lithium, among carbon materials. The above negative electrode material, since storing and releasing lithium and electrons at an extremely less noble potential equivalent to that of lithium metal, has a possibility that many solvents may be reductively decomposed particularly at high temperatures. Hence, regardless of the type of negative electrode material, a part of the solvent in the electrolytic solution is reductively decomposed on the negative electrode, and thereby, deposition of decomposed products, generation of gases and swelling of the electrode occur, thereby disturbing migration of lithium ions and posing problems that battery properties such as high-temperature storage properties are deteriorated especially at high temperatures, that the battery is deformed due to the swelling of the electrode, and the like. Further, although a lithium secondary battery where lithium metal and alloy with lithium metal, metal element such as tin, silicon or the like, or oxide is used as the negative electrode material has high initial capacity. However, because of proceeding a pulverization of the negative electrode material during a cycle, a reductive decomposition of the nonaqueous solvent occurs with increasing speed compared to the negative electrode of the carbon material, and particularly at high temperatures, it is known that problems such as great deterioration of battery performance like battery capacity and high-temperature storage properties, etc., and deformation of the battery due to swelling of the electrode tend to occur more easily.

On the other hand, researches have been actively carried out on positive electrode materials operating at high voltages in order to enhance the energy density. Particularly materials of capable of absorbing and releasing lithium, such as LiNi_{0.5}Mn_{1.5}O₄, LiNi_{0.5}Co_{0.2}Mn_{0.3}O₂ and solid solutions of Li₂MnO₃ and LiMO₂ (M is a transitional metal such as Co, Ni, M, and Fe), since storing and releasing lithium and electrons at a noble voltage of 4.5 V or higher on Li basis, has a possibility that many solvents may undergo an oxidative decomposition particularly at high temperatures. Hence, not depending on the types of positive electrode material, a part of the solvent in the electrolytic solution is oxidatively decomposed on the positive electrode, and there thereby occur deposition of decomposed products, evolution of gases and the like, thereby disturbing migration of lithium ions and posing a problem that battery properties such as high-temperature storage properties are deteriorated.

Patent Document 1 proposes a nonaqueous electrolytic solution secondary battery using a nonaqueous electrolytic solution containing a halogen-substituted carbonic acid ester or chain carboxylic acid ester whose main skeleton carbons are saturated, and a positive electrode active material absorbing and releasing Li at 4.5 V or higher, and describes that the charge and discharge cycle properties at 45° C. are improved.

### RELATED DOCUMENT

### Patent Document

### Patent Document 1: Japanese Patent Publication No. 2012-238608

### SUMMARY OF INVENTION

### Problem to be Solved by Invention

As a result of detailed studies by the present inventors on the performance of the nonaqueous electrolytic solutions of the above conventional technologies, the nonaqueous electrolyte secondary battery of Patent Document 1 cannot sufficiently satisfy the effect on the problem of improving the high-temperature storage properties in the case where an energy storage device is used at high voltages.

Then, as a result of intensive studies to solve the above problem, the present inventors have found that by adding a specific tertiary carboxylic acid ester into a nonaqueous electrolytic solution, there can be improved the high-temperature storage properties of an energy storage device using a positive electrode in a full-charge state having a potential of 4.5 V or higher on Li basis, and thus completed the present invention.

The present invention has an object to provide a nonaqueous electrolytic solution capable of improving the high-temperature storage properties in the case where an energy storage device is used at high voltages, and the energy storage device using the same.

### Means for Solving Problems

That is, the present invention provides the following (1) and (2).

(1) A nonaqueous electrolytic solution for an energy storage device provided with a positive electrode, a negative electrode, a separator and a nonaqueous electrolytic solution having an electrolyte salt dissolved in a nonaqueous solvent, wherein the potential of the positive electrode in a full-charge state is 4.5 V or higher on Li basis; and the nonaqueous electrolytic solution contains at least one kind of tertiary carboxylic acid esters represented by the following general formula (I).

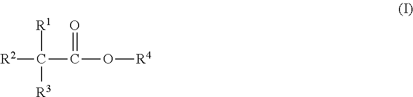

wherein R¹ to R³ each independently represent a methyl group or an ethyl group; and R⁴ represents a halogenated alkyl group having 1 to 5 carbon atoms.

(2) An energy storage device provided with a positive electrode, a negative electrode, a separator and a nonaqueous electrolytic solution having an electrolyte salt dissolved in a nonaqueous solvent, wherein the potential of the positive electrode in a full-charge state is 4.5 V or higher on Li basis; and the nonaqueous electrolytic solution contains at least one kind of tertiary carboxylic acid esters represented by the following general formula (I).

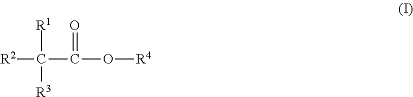

wherein R¹ to R³ each independently represent a methyl group or an ethyl group; and R⁴ represents a halogenated alkyl group having 1 to 5 carbon atoms.

### Effects of Invention

According to the present invention, there can be provided a nonaqueous electrolytic solution capable of improving the high-temperature storage properties in the case where an energy storage device is used at high voltages, and the energy storage device such as a lithium battery using the same.

### MODES FOR CARRYING OUT THE INVENTION

The present invention relates to a nonaqueous electrolytic solution and an energy storage device using the same.

### [Nonaqueous Electrolytic Solution]

The nonaqueous electrolytic solution of the present invention is a nonaqueous electrolytic solution having an electrolyte salt dissolved in a nonaqueous solvent, wherein the nonaqueous electrolytic solution contains a compound represented by the above general formula (I).

The present inventors have found that when a nonaqueous electrolytic solution is used in which a tertiary carboxylic acid ester having a specific structure is contained, the high-temperature storage properties at high temperatures and high voltages, which are a conventional problem, are improved.

The compound contained in the nonaqueous electrolytic solution of the present invention is represented by the following general formula (I).

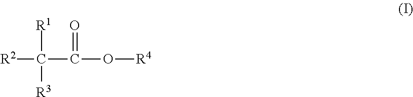

wherein R¹ to R³ each independently represent a methyl group or an ethyl group; and R⁴ represents a halogenated alkyl group having 1 to 5 carbon atoms.

In the above general formula (I), R¹ to R³ represent a methyl group or an ethyl group, preferably a methyl group. R⁴ represents a halogenated alkyl group having 1 to 5 carbon atoms; preferably a halogenated alkyl group having 2 to 5 carbon atoms, wherein the carbon atom bonded directly to an oxygen atom of the ester group is non-substituted by a halogen atom (that is, preferably halogenated alkyl group, wherein the carbon atom bonded directly to an oxygen atom of the ester group is not substituted by a halogen atom, and among the carbon atoms other than the carbon atom bonded directly to an oxygen atom of the ester group, at least one carbon atom is substituted by at least one halogen atom); more preferably a fluorinated alkyl group having 2 to 5 carbon atoms and having at least three fluorine atoms; and further preferably, among the fluorinated alkyl groups having 2 to 5 carbon atoms, one where hydrogen atoms on the carbon atom of the terminal of R⁴ are all substituted by fluorine atoms.

As specific examples of R⁴, halogenated alkyl groups such as a fluoromethyl group, difluoromethyl group, 2-chloroethyl group, 2-fluoroethyl group, 2,2-difluoroethyl group, 2,2,2-trifluoroethyl group, 3-fluoropropyl group, 3-chloropropyl group, 3,3-difluoropropyl group, 3,3,3-trifluoropropyl group, 2,2,3,3-tetrafluoropropyl group, 2,2,3,3,3-pentafluoropropyl group and 1,1,1,3,3,3-hexafluoro-2-propyl group may be suitably mentioned. Among the above, 2-chloroethyl group, 2-fluoroethyl group, 2,2-difluoroethyl group, 2,2,2-trifluoroethyl group, 3-fluoropropyl group, 3-chloropropyl group, 3,3-difluoropropyl group, 3,3,3-trifluoropropyl group, 2,2,3,3-tetrafluoropropyl group, 2,2,3,3,3-pentafluoropropyl group or 1,1,1,3,3,3-hexafluoro-2-propyl group are preferable; and 2,2,2-trifluoroethyl group, 3,3,3-trifluoropropyl group, 2,2,3,3-tetrafluoropropyl group, or 2,2,3,3,3-pentafluoropropyl group are more preferable; and 2,2,2-trifluoroethyl group, or 2,2,3,3,3-pentafluoropropyl group are particularly preferable.

As specific examples of the tertiary carboxylic acid ester represented by the general formula (I), fluoromethyl pivalate, difluoromethyl pivalate, 2-chloroethyl pivalate, 2-fluoroethyl pivalate, 2,2-difluoroethyl pivalate, 2,2,2-trifluoroethyl pivalate, 3-fluoropropyl pivalate, 3-chloropropyl pivalate, 3,3-difluoropropyl pivalate, 3,3,3-trifluoropropyl pivalate, 2,2,3,3-tetrafluoropropyl pivalate, 2,2,3,3,3-pentafluoropropyl pivalate, 1,1,1,3,3,3-hexafluoro-2-propyl pivalate, 2,2,2-trifluoroethyl 2,2-dimethylbutanoate, 2,2,2-trifluoroethyl 2-ethyl-2-methylbutanoate, or 2,2,2-trifluoroethyl 2,2-di ethylbutanoate may be suitably mentioned. Among the above, 2,2,2-trifluoroethyl pivalate, 2,2,3,3-tetrafluoropropyl pivalate or 2,2,3,3,3-pentafluoropropyl pivalate are preferable; and 2,2,2-trifluoroethyl pivalate or 2,2,3,3,3-pentafluoropropyl pivalate are more preferable.

In the nonaqueous electrolytic solution of the present invention, the content of the tertiary carboxylic acid ester represented by the general formula (I) is preferably 1 to 50% by volume with respect to the total volume of a nonaqueous solvent. When the content is 50% by volume or lower, there is little fear that a coating film is excessively formed on an electrode and the high-temperature storage properties in the case where a battery is used at high temperatures and high voltages are deteriorated; and when the content is 1% by volume or higher, the formation of the coating film is sufficient and there is thereby enhanced an improving effect of the high-temperature storage properties in the case where an energy storage device is used at high voltages. The content is, with respect to the total volume of a nonaqueous solvent, preferably 3% by volume or higher and more preferably 5% by volume or higher. Further the upper limit thereof is preferably 50% by volume or lower, more preferably 45% by volume or lower, and particularly preferably 40% by volume or lower.

### [Nonaqueous Solvent]

As a nonaqueous solvent used in the nonaqueous electrolytic solution of the present invention, any nonaqueous solvent can be used as long as it contains a tertiary carboxylic acid ester represented by the general formula (I), and those further containing one or more kinds selected from the group consisting of cyclic carbonates, chain esters (excluding ones which correspond to tertiary carboxylic acid esters represented by the general formula (I), and the same is applied hereinafter), sulfones, lactones, ethers and amides may be suitably mentioned, and those further containing two or more kinds selected from the group consisting thereof are more suitable. From the viewpoint of synergistically improving the electrochemical properties at high temperatures, preferably a chain ester is contained; more preferably, a chain carbonate is contained; and most preferably, both of a cyclic carbonate and a chain ester are contained.

Incidentally, the term “chain ester” is used as a concept including chain carbonates and chain carboxylic acid esters.

As the cyclic carbonate, one or two or more kinds selected from ethylene carbonate (EC), propylene carbonate (PC), 1,2-butylene carbonate, 2,3-butylene carbonate, 4-fluoro-1,3-dioxolan-2-one (FEC), trans- or cis-4,5-difluoro-1,3-dioxolan-2-one (hereinafter, both of them are collectively referred to as “DFEC”), vinylene carbonate (VC), vinyl ethylene carbonate (VEC), and 4-ethynyl-1,3-dioxolan-2-one (EEC) may be suitably mentioned; one or more kinds selected from the group consisting of ethylene carbonate, propylene carbonate, 4-fluoro-1,3-dioxolan-2-one, vinylene carbonate and 4-ethynyl-1,3-dioxolan-2-one (EEC) is suitable; and two or more kinds are more suitable.

Further, it is preferable to use at least one kind selected from cyclic carbonates having an unsaturated bond such as carbon-carbon double bond or carbon-carbon triple bond or the like or having a fluorine atom since electrochemical properties at high temperatures can be even more improved; and it is more preferable that there be contained both of a cyclic carbonate having an unsaturated bond such as carbon-carbon double bond or carbon-carbon triple bond or the like and a cyclic carbonate having a fluorine atom. As the cyclic carbonate having an unsaturated bond such as carbon-carbon double bond or carbon-carbon triple bond or the like, VC, VEC, or EEC are more preferable; and as the cyclic carbonate having a fluorine atom, FEC or DFEC are more preferable.

The content of the cyclic carbonate having an unsaturated bond such as carbon-carbon double bond or carbon-carbon triple bond or the like is, with respect to the total volume of a nonaqueous solvent, preferably 0.07% by volume or higher, more preferably 0.2% by volume or higher, and still more preferably 0.7% by volume or higher; and further when the upper limit thereof is preferably 7% by volume or lower, more preferably 4% by volume or lower, and still more preferably 2.5% by volume or lower, it is preferable since the stability of the coating film at high temperatures can be even more increased without impairing the Li ion permeability.

The content of the cyclic carbonate having a fluorine atom is, with respect to the total volume of the nonaqueous solvent, preferably 0.07% by volume or higher, more preferably 4% by volume or more, still more preferably 7% by volume or higher, and particularly preferably 10% by volume or higher; and further when the upper limit thereof is preferably 35% by volume or lower, more preferably 33% by volume or lower, and still more preferably 30% by volume or lower, it is preferable since the stability of the coating film at high temperatures can be even more increased without impairing the Li ion permeability.

Particularly in the case where the cyclic carbonate having a fluorine atom is contained in the range of 10 to 35% by volume, when the tertiary carboxylic acid ester represented by the general formula (I) is contained in the range of 10 to 40% by volume, the content of the tertiary carboxylic acid ester is preferable since the high-temperature storage properties at high temperatures and high voltages can be even more improved.

In the case where the nonaqueous solvent contains both of the cyclic carbonate having an unsaturated bond such as carbon-carbon double bond or carbon-carbon triple bond or the like and the cyclic carbonate having a fluorine atom, the content of the cyclic carbonate having an unsaturated bond such as carbon-carbon double bond or carbon-carbon triple bond or the like is, with respect to the total content of the cyclic carbonate having an unsaturated bond such as carbon-carbon double bond or carbon-carbon triple bond or the like and the cyclic carbonate having a fluorine atom, preferably 0.2% by volume or higher, more preferably 3% by volume or higher, and still more preferably 7% by volume or higher; and when the upper limit thereof is preferably 50% by volume or lower, more preferably 40% by volume or lower, and still more preferably 30% by volume or lower, it is particularly preferable since the stability of the coating film at high temperatures can be even more increased without impairing the Li ion permeability.

When the nonaqueous solvent contains both of ethylene carbonate and the cyclic carbonate having an unsaturated bond such as carbon-carbon double bond or carbon-carbon triple bond or the like, it is preferable since the stability at high temperatures of the coating film formed on the electrode increases; and the content of ethylene carbonate and the cyclic carbonate having an unsaturated bond such as carbon-carbon double bond or carbon-carbon triple bond or the like is, with respect to the total volume of the nonaqueous solvent, preferably 3% by volume or higher, more preferably 5% by volume or higher, and still more preferably 7% by volume or higher; and further the upper limit thereof is preferably 45% by volume or lower, more preferably 35% by volume or lower, and still more preferably 25% by volume or lower.

These solvents may be used in one kind thereof; the case of using two or more kinds thereof in combination is preferable since the electrochemical properties at high temperatures are further improved, and using three or more kinds thereof in combination is particularly preferable. As suitable combinations of these cyclic carbonates, EC and PC, EC and VC, PC and VC, VC and FEC, EC and FEC, PC and FEC, FEC and DFEC, EC and DFEC, PC and DFEC, VC and DFEC, VEC and DFEC, VC and EEC, EC and EEC, EC and PC and VC, EC and PC and FEC, EC and VC and FEC, EC and VC and VEC, EC and VC and EEC, EC and EEC and FEC, PC and VC and FEC, EC and VC and DFEC, PC and VC and DFEC, EC and PC and VC and FEC, EC and PC and VC and DFEC, or the like are preferable. Among the above combinations, combinations of EC and VC, EC and FEC, PC and FEC, EC and PC and VC, EC and PC and FEC, EC and VC and FEC, EC and VC and EEC, EC and EEC and FEC, PC and VC and FEC, EC and PC and VC and FEC, or the like are more preferable; and combinations including PC such as PC and FEC, EC and PC and VC, EC and PC and FEC, PC and VC and FEC, and EC and PC and VC and FEC, or the like are still more preferable, since the battery properties at high voltages are made to be improved.

As the chain ester, one or two or more kinds of asymmetrical chain carbonates selected from methyl ethyl carbonate (MEC), methyl propyl carbonate (MPC), methyl isopropyl carbonate (MIPC), methyl butyl carbonate and ethyl propyl carbonate, one or two or more kinds of symmetrical chain carbonates selected from dimethyl carbonate (DMC), diethyl carbonate (DEC), dipropyl carbonate and dibutyl carbonate, and one or more kinds of chain carboxylic acid esters selected from the group consisting of methyl pivalate (MPiv), ethyl pivalate (EPiv), propyl pivalate (PPiv), methyl propionate (MP), ethyl propionate (EP), methyl acetate (MA) and ethyl acetate (EA) may be suitably mentioned; and two or more kinds are more suitable.

Among the above chain esters, chain esters having a methyl group selected dimethyl carbonate (DMC), methyl ethyl carbonate (MEC), methyl propyl carbonate (MPC), methyl isopropyl carbonate (MTPC), methyl butyl carbonate, methyl propionate (MP), methyl acetate (MA) and ethyl acetate (EA) are preferable; and chain carbonates having a methyl group are particularly preferable.

Further from the viewpoint of improving the electrochemical properties at high voltages, it is preferable that there be contained at least one kind of fluorinated chain carbonates represented by the following general formula (II).

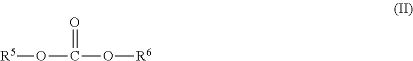

wherein R⁵ represents a fluorinated alkyl group having 1 to 4 carbon atoms; and R⁶ represents an alkyl group having 1 to 4 carbon atoms in which at least one hydrogen atom is substituted or not substituted by a fluorine atom.

As specific examples of the fluorinated chain carbonates represented by the general formula (II), methyl (2,2,2-trifluoroethyl) carbonate (MTFEC), ethyl (2,2,2-trifluoroethyl) carbonate, fluoromethyl (methyl) carbonate (FMMC), methyl (2,2-difluoroethyl) carbonate (MDFEC), ethyl (2,2-difluoroethyl) carbonate (EDFEC), methyl (2,2,3,3-tetrafluoropropyl) carbonate (MTEFPC), ethyl (2,2,3,3-tetrafluoropropyl) carbonate, methyl (2,2,3,3,3-pentafluoropropyl) carbonate (MPEFPC), ethyl (2,2,3,3,3-pentafluoropropyl) carbonate, 2-fluoroethyl (methyl) carbonate (2-FEMC), difluoromethyl (fluoromethyl) carbonate, bis(2-fluoroethyl) carbonate, bis(2,2,3,3-tetrafluoropropyl) carbonate, bis(2,2,2-trifluoroethyl) carbonate, and bis(fluoromethyl) carbonate may be suitably mentioned. Among these, fluorinated chain carbonates having a methyl group selected from methyl (2,2,2-trifluoroethyl) carbonate (MTFEC), 2-fluoroethyl (methyl) carbonate (2-FEMC), methyl (2,2,3,3-tetrafluoropropyl) carbonate (MTEFPC), and methyl (2,2,3,3,3-pentafluoropropyl) carbonate (MPEFPC) are more preferable; and methyl (2,2,2-trifluoroethyl) carbonate (MTFEC) is particularly preferable.

In the case of using chain carbonates, use of two or more kinds thereof is preferable. It is more preferable that there be contained both of a symmetrical chain carbonate and an asymmetrical chain carbonate; and it is still more preferable that the content of the symmetrical chain carbonate be higher than that of the asymmetrical chain carbonate.

The content of the chain ester is not particularly limited, but the content thereof is preferably in the range of 60 to 90% by volume with respect to the total volume of the nonaqueous solvent. The above range is preferable since when the content thereof is 60% by volume or higher, the viscosity of the nonaqueous electrolytic solution does not become too high; and when being 90% by volume or lower, there is little fear of deteriorating the electrochemical properties at high temperatures due to a decrease in the electrical conductivity of the nonaqueous electrolytic solution.

The proportion of the volume occupied by symmetrical chain carbonates in chain carbonates is preferably 51% by volume or higher, and more preferably 55% by volume or higher. The upper limit thereof is more preferably 95% by volume or lower, and still more preferably 85% by volume or lower. It is particularly preferable that dimethyl carbonate be contained in the symmetrical chain carbonates. Further, the asymmetrical chain carbonate more preferably contains a methyl group, and is particularly preferably methyl ethyl carbonate. The above case is preferable since the electrochemical properties at high temperatures are even more improved.

With respect to the proportion of the cyclic carbonate and the chain ester, from the viewpoint of improving the electrochemical properties at high temperatures, the cyclic carbonate: the chain ester (in volume ratio) is preferably 10:90 to 45:55, more preferably 15:85 to 40:60, and particularly preferably 20:80 to 35:65.

As other nonaqueous solvents, one or more kinds selected from the group consisting of sulfones such as dimethyl sulfone, diethyl sulfone and sulfolane and lactones such as γ-butyrolactone (GBL), γ-valerolactone and α-angelicalactone may be suitably mentioned; and two or more kinds are more suitable.

When the content of the sulfones and the lactones is in the range of 5 to 40% by volume with respect to the total volume of the nonaqueous solvent, it is preferable since the high-temperature storage properties at high temperatures and high voltages can be even more improved.

The nonaqueous solvent is usually used in a mixture in order to accomplish appropriate physical properties. As the combination, combinations of a cyclic carbonate and a chain carbonate, combinations of a cyclic carbonate and a chain carboxylic acid ester, combinations of a cyclic carbonate, a chain carbonate and a lactone, combinations of a cyclic carbonate, a chain carbonate and a sulfone, combinations of a chain carbonate and a sulfone, combinations of a cyclic carbonate, a chain carbonate and an ether, or combinations of a cyclic carbonate, a chain carbonate and a chain carboxylic acid ester may be suitably mentioned.

For the purpose of even more improving the stability of the coating film at high temperatures, it is preferable that other additives be further added to the nonaqueous electrolytic solution.

Specific examples of the other additives include the following (A) to (G) compounds.

(A) One or more kinds of nitrile compounds selected from the group consisting of acetonitrile, propionitrile, succinonitrile, glutaronitrile, adiponitrile, pimelonitrile, suberonitrile, and sebaconitrile.

(B) One or more kinds of isocyanate compounds selected from the group consisting of methyl isocyanate, ethyl isocyanate, butyl isocyanate, phenyl isocyanate, tetramethylene diisocyanate, hexamethylene diisocyanate, octamethylene diisocyanate, 1,4-phenylene diisocyanate, 2-isocyanatoethyl acrylate, and 2-isocyanatoethyl methacrylate.

(C) One or more kinds of compounds containing a triple bond selected from the group consisting of 2-propynyl methyl carbonate, 2-propynyl acetate, 2-propynyl formate, 2-propynyl methacrylate, 2-propynyl methanesulfonate, 2-propynyl vinylsulfonate, 2-propynyl 2-(methanesulfonyloxy)propionate, di(2-propynyl) oxalate, methyl 2-propynyl oxalate, ethyl 2-propynyl oxalate, di(2-propynyl) glutarate, 2-butyne-1,4-diyl dimethanesulfonate, 2-butyne-1,4-diyl diformate, and 2,4-hexadiyne-1,6-diyl dimethanesulfonate.

(D) One or more kinds of cyclic or chain S(═O) group-containing compounds selected from the group consisting of sultones such as 1,3-propanesultone, 1,3-butanesultone, 2,4-butanesultone, 1,4-butanesultone, 1,3-propenesultone, 2,2-dioxide-1,2-oxathiolane-4-yl acetate or 5,5-dimethyl-1,2-oxathiolane-4-one 2,2-dioxide, cyclic sulfites such as ethylene sulfite, hexahydrobenzo[1,3,2]dioxathiolane-2-oxide (also called 1,2-cyclohexanediol cyclic sulfite), 5-vinyl-hexahydro-1,3,2-benzodioxathiol-2-oxide or 4-(methylsulfonylmethyl)-1,3,2-dioxathiolane 2-oxide, cyclic sulfates such as ethylene sulfate, [4,4′-bi(1,3,2-dioxathiolane)] 2,2′,2′-tetraoxide, (2,2-dioxide-1,3,2-dioxathiolane-4-yl)methyl methanesulfonate or 4-((methylsulfonyl)methyl)-1,3,2-dioxathiolane 2,2-dioxide, sulfonic acid esters such as butane-2,3-diyl dimethanesulfonate, butane-1,4-diyl dimethanesulfonate and methylene methanedisulfonate, and vinyl sulfone compounds such as divinyl sulfone, 1,2-bis(vinylsulfonyl)ethane or bis(2-vinylsulfonylethyl) ether.

(E) One or more kinds of phosphorus-containing compounds selected from the group consisting of trimethyl phosphate, tributyl phosphate, trioctyl phosphate, tris(2,2,2-trifluoroethyl) phosphate, bis(2,2,2-trifluoroethyl) methyl phosphate, bis(2,2,2-trifluoroethyl) ethyl phosphate, bis(2,2,2-trifluoroethyl) 2,2-difluoroethyl phosphate, bis(2,2,2-trifluoroethyl) 2,2,3,3-tetrafluoropropyl phosphate, bis(2,2-difluoroethyl) 2,2,2-trifluoroethyl phosphate, bis(2,2,3,3-tetrafluoropropyl) 2,2,2-trifluoroethyl phosphate, (2,2,2-trifluoroethyl) (2,2,3,3-tetrafluoropropyl) methyl phosphate, tris(1,1,1,3,3,3-hexafluoropropan-2-yl) phosphate, methyl methylene bisphosphonate, ethyl methylene bisphosphonate, methyl ethylene bisphosphonate, ethyl ethylene bisphosphonate, methyl butylene bisphosphonate, ethyl butylene bisphosphonate, methyl 2-(dimethylphosphoryl)acetate, ethyl 2-(dimethyl phosphoryl)acetate, methyl 2-(diethylphosphoryl)acetate, ethyl 2-(diethylphosphoryl)acetate, 2-propynyl 2-(dimethylphosphoryl)acetate, 2-propynyl 2-(diethylphosphoryl)acetate, methyl 2-(dimethoxyphosphoryl)acetate, ethyl 2-(dimethoxyphosphoryl)acetate, methyl 2-(diethoxyphosphoryl)acetate, ethyl 2-(diethoxyphosphoryl)acetate, 2-propynyl 2-(dimethoxyphosphoryl)acetate, 2-propynyl 2-(diethoxyphosphoryl)acetate, methyl pyrophosphate and ethyl pyrophosphate.

(F) Chain carboxylic acid anhydrides such as acetic anhydride and propionic anhydride, and cyclic acid anhydrides such as succinic anhydride, maleic anhydride, 3-allylsuccinic anhydride, glutaric anhydride, itaconic anhydride or 3-sulfopropionic anhydride.

(G) Cyclic phosphazene compounds such as methoxypentafluorocyclotriphosphazene, ethoxypentafluorocyclotriphosphazene, phenoxypentafluorocyclotriphosphazene or ethoxyheptafluorocyclotetraphosphazene.

Among the above, containing at least one or more kinds selected from the group consisting of the (A) nitrile compounds and the (B) isocyanate compounds is preferable since the high-temperature storage properties at high voltages is even more improved.

Among the (A) nitrile compounds, one or more kinds of nitriles selected from the group consisting of succinonitrile, glutaronitrile, adiponitrile, pimelonitrile, suberonitrile and sebaconitrile are preferable; and one or more kinds selected from succinonitrile, glutaronitrile, adiponitrile and pimelonitrile are more preferable.

Among the (B) isocyanate compounds, one or more kinds selected from the group consisting of hexamethylene diisocyanate, octamethylene diisocyanate, 2-isocyanatoethyl acrylate and 2-isocyanatoethyl methacrylate are more preferable.

The content of the (A) compounds in the nonaqueous electrolytic solution is preferably 0.01 to 20% by mass. When the content is in this range, the coating film can be formed sufficiently without becoming too thick, and the stability of the coating film at high temperatures is thereby even more enhanced. The content in the nonaqueous electrolytic solution is more preferably 0.1% by mass or higher and still more preferably 1% by mass or higher; and the upper limit thereof is more preferably 15% by mass or lower and still more preferably 10% by mass or lower.

The content of the (B) compounds in the nonaqueous electrolytic solution is preferably 0.01 to 7% by mass. When the content is in this range, the coating film can be formed sufficiently without becoming too thick, and the stability of the coating film at high temperatures is thereby even more enhanced. The content in the nonaqueous electrolytic solution is more preferably 0.05% by mass or higher and still more preferably 0.1% by mass or higher; and the upper limit thereof is more preferably 5% by mass or lower and still more preferably 3% by mass or lower.

Further when there are contained the (C) compounds containing a triple bond, the (D) cyclic or chain S(═O) group-containing compounds selected from the group consisting of sultones, cyclic sulfites, sulfonic acid esters and vinyl sulfones, the (E) phosphorus-containing compounds, the (F) cyclic acid anhydrides, or the (G) cyclic phosphazene compounds, it is preferable since the stability of the coating film at high temperatures is even more improved.

Among the (C) compounds containing a triple bond, one or more kinds selected from the group consisting of 2-propynyl methyl carbonate, 2-propynyl methacrylate, 2-propynyl methanesulfonate, 2-propynyl vinylsulfonate, 2-propynyl 2-(methanesulfonyloxy)propionate, di(2-propynyl) oxalate, methyl 2-propynyl oxalate, ethyl 2-propynyl oxalate and 2-butyne-1,4-diyl dimethanesulfonate are preferable; and one or more kinds selected from the group consisting of 2-propynyl methanesulfonate, 2-propynyl vinylsulfonate, 2-propynyl 2-(methanesulfonyloxy)propionate, di(2-propynyl) oxalate and 2-butyne-1,4-diyl dimethanesulfonate are more preferable.

It is preferable to use the (D) cyclic or chain S(═O) group-containing compounds (however, not including compounds containing a triple bond) selected from sultones, cyclic sulfites, sulfonic acid esters and vinyl sulfones.

As the cyclic S(═O) group-containing compounds, one or more kinds selected from the group consisting of 1,3-propanesultone, 1,3-butanesultone, 1,4-butanesultone, 2,4-butanesultone, 1,3-propenesultone, 2,2-dioxide-1,2-oxathiolane-4-yl acetate, 5,5-dimethyl-1,2-oxathiolane-4-one 2,2-dioxide, methyl ene methanedisulfonate, ethylene sulfite and 4-(methylsulfonylmethyl)-1,3,2-dioxathiolane 2-oxide may be suitably mentioned.

Further as the chain S(═O) group-containing compounds, one or more kinds selected from the group consisting of butane-2,3-diyl dimethanesulfonate, butane-1,4-diyl dimethanesulfonate, dimethyl methanedisulfonate, pentafluorophenyl methanesulfonate, divinyl sulfone and bis(2-vinylsulfonylethyl) ether may be suitably mentioned.

Among the cyclic or chain S(═O) group-containing compounds, one or more kinds selected from the group consisting of 1,3-propanesultone, 1,4-butanesultone, 2,4-butanesultone, 2,2-dioxide-1,2-oxathiolane-4-yl acetate, 5,5-dimethyl-1,2-oxathiolane-4-one 2,2-dioxide, butane-2,3-diyl dimethanesulfonate, pentafluorophenyl methanesulfonate and divinyl sulfone are more preferable.

Among the (E) phosphorus-containing compounds, tris(2,2,2-trifluoroethyl) phosphate, tris(1,1,1,3,3,3-hexafluoropropan-2-yl) phosphate, methyl 2-(dimethylphosphoryl)acetate, ethyl 2-(dimethylphosphoryl)acetate, methyl 2-(diethylphosphoryl)acetate, ethyl 2-(diethylphosphoryl)acetate, 2-propynyl 2-(dimethylphosphoryl)acetate, 2-propynyl 2-(diethylphosphoryl)acetate, methyl 2-(dimethoxyphosphoryl)acetate, ethyl 2-(dimethoxyphosphoryl)acetate, methyl 2-(diethoxyphosphoryl)acetate, ethyl 2-(diethoxyphosphoryl)acetate, 2-propynyl 2-(dimethoxyphosphoryl)acetate or 2-propynyl 2-(diethoxyphosphoryl)acetate are preferable; and tris(2,2,2-trifluoroethyl) phosphate, tris(1,1,1,3,3,3-hexafluoropropan-2-yl) phosphate, ethyl 2-(diethylphosphoryl)acetate, 2-propynyl 2-(dimethylphosphoryl)acetate, 2-propynyl 2-(diethylphosphoryl)acetate, ethyl 2-(diethoxyphosphoryl)acetate, 2-propynyl 2-(dimethoxyphosphoryl)acetate or 2-propynyl 2-(diethoxyphosphoryl)acetate are more preferable.

Among the (F) cyclic acid anhydrides, succinic anhydride, maleic anhydride or 3-allylsuccinic anhydride are preferable; and succinic anhydride or 3-allylsuccinic anhydride are more preferable.

Among the (G) cyclic phosphazene compounds, cyclic phosphazene compounds such as methoxypentafluorocyclotriphosphazene, ethoxypentafluorocyclotriphosphazene or phenoxypentafluorocyclotriphosphazene are preferable; and methoxypentafluorocyclotriphosphazene or ethoxypentafluorocyclotriphosphazene are more preferable.

The content of the (C) to (G) compounds in the nonaqueous electrolytic solution is preferably 0.001 to 5% by mass. When the content is in this range, the coating film can be formed sufficiently without becoming too thick, and the stability of the coating film at high temperatures is thereby even more enhanced. The content thereof in the nonaqueous electrolytic solution is more preferably 0.01% by mass or higher and still more preferably 0.1% by mass or higher; and the upper limit thereof is more preferably 3% by mass or lower, and still more preferably 2% by mass or lower.

Further for the purpose of even more improving the stability of the coating film at high temperatures, it is preferable that in the nonaqueous electrolytic solution, there be further contained one or more kinds of lithium salts selected from lithium salts having an oxalic acid skeleton, lithium salts having a phosphoric acid skeleton and lithium salts having an S(═O) group. The one or more kinds of lithium salts selected from lithium salts having an oxalic acid skeleton, lithium salts having a phosphoric acid skeleton and lithium salts having an S(═O) group act as electrolyte salts in the nonaqueous electrolytic solution.

As specific examples of the lithium salts, at least one kinds of lithium salts having an oxalic acid skeleton selected from lithium bis(oxalato)borate (LiBOB), lithium difluoro(oxalato)borate (LiDFOB), lithium tetrafluoro(oxalato)phosphate (LiTFOP) and lithium difluorobis(oxalato)phosphate (LiDFOP), lithium salts having a phosphoric acid skeleton such as lithium difluorophosphate (LiPO₂F₂) and lithium fluorophosphate (Li₂PO₃F), and one or more kinds of lithium salts having an S(═O) group selected from the group consisting of lithium trifluoro((methanesulfonyl)oxy)borate (LiTFMSB), lithium pentafluoro((methanesulfonyl)oxy)phosphate (LiPFMSP), lithium methylsulfate (LMS), lithium ethylsulfate (LES), lithium 2,2,2-trifluoroethylsulfate (LFES) and lithium fluorosulfonate (FSO₃Li) may be suitably mentioned; and one or more kinds of lithium salts selected from the group consisting of LiBOB, LiDFOB, LiTFOP, LiDFOP, LiPO₂F₂, LiTFMSB, LMS, LES, LFES and FSO₃Li are more preferable.

The total content of one or more kinds of lithium salts selected from LiBOB, LiDFOB, LiTFOP, LiDFOP, LiPO₂F₂, Li₂PO₃F, LiTFMSB, LiPFMSP, LMS, LES, LFES and FSO₃Li is preferably 0.001 to 10% by mass in the nonaqueous electrolytic solution. When the content is 10% by mass or lower, there is little fear that the coating film is excessively formed on the electrode, and the storage properties are thereby deteriorated; and further when being 0.001% by mass or higher, the formation of the coating film is sufficient and there is thereby enhanced an improving effect of the properties in the case of the use at high temperatures and high voltages. The content is, in the nonaqueous electrolytic solution, preferably 0.05% by mass or higher, more preferably 0.1% by mass or higher, and still more preferably 0.3% by mass or higher; and the upper limit thereof is preferably 5% by mass or lower, more preferably 3% by mass or lower, and still more preferably 2% by mass or lower.

Here, the total molar concentration of one or more kinds of lithium salts selected from LiBOB, LiDFOB, LiTFOP, LiDFOP, LiPO₂F₂, Li₂PO₃F, LiTFMSB, LiPFMSP, LMS, LES, LFES and FSO₃Li is preferably 0.001M or higher and 0.4M or lower in the nonaqueous electrolytic solution. The content is, in the nonaqueous electrolytic solution, preferably 0.01M or higher, and more preferably 0.03M or higher; and the upper limit thereof is preferably 0.35M or lower, and more preferably 0.3M or lower.

### (Electrolyte Salt)

The electrolyte salt to be used in the present invention includes lithium salts (excluding the above-mentioned lithium salts having an oxalic acid skeleton, lithium salts having a phosphoric acid skeleton and lithium salts having an S(═O) group), and particularly the following lithium salts may be suitably mentioned.

As the lithium salts, inorganic lithium salts such as LiPF₆, LiBF₄ and LiClO₄, lithium salts having a chain fluorinated alkyl group such as LiN(SO₂F)₂ [abbreviated to FSI], LiN(SO₂CF₃)₂ [abbreviated to TFSI], LiN(SO₂C₂F₅)₂, LiCF₃SO₃, LiC(SO₂CF₃)₃, LiPF₄(CF₃)₂, LiPF₃(C₂F₅)₃, LiPF₃(CF₃)₃, LiPF₃(iso-C₃F₇)₃ and LiPF₅(iso-C₃F₇), and lithium salts having a cyclic fluorinated alkylene chain such as (CF₂)₂(SO₂)₂NLi and (CF₂)₃(SO₂)₂NLi may be suitably mentioned; at least one kind of lithium salt selected therefrom may be suitably mentioned; and these may be used singly or by mixing two or more thereof.

Among these, one or two or more kinds selected from LiPF₆, LiBF₄, LiN(SO₂CF₃)₂[TFSI], LiN(SO₂C₂F₅)₂ and LiN(SO₂F)₂ [FSI] are preferable; and LiPF₆ is most preferably used. The concentration of the lithium salts is, with respect to the nonaqueous solvent, usually preferably 0.3M or higher, more preferably 0.7M or higher, and still more preferably 1.1M or higher. The upper limit thereof is preferably 2.5M or lower, more preferably 2.0M or lower, and still more preferably 1.6M or lower.

Further, suitable combinations of these lithium salts are preferably the case where LiPF₆ and further at least one kind of lithium salts selected from LiBF₄, LiN(SO₂CF₃)₂[TFSI] and LiN(SO₂F)₂ [FSI] are contained in the nonaqueous electrolytic solution, and the case where LiPF₆ and further at least one kind of lithium salts selected from the above-described lithium salts having an oxalic acid skeleton, lithium salts having a phosphoric acid skeleton and lithium salts having an S(═O) group are contained in the nonaqueous electrolytic solution. The proportion of lithium salts other than LiPF₆ in the nonaqueous solvent is preferably 0.001M or higher, because the improvement effect of the electrochemical properties can be easily exhibited when a battery is used at high temperatures. The proportion of 1.0M or lower preferably decreases concerns that the improvement effect of the electrochemical properties is reduced when the battery is used at high temperatures. The proportion is preferably 0.01M or higher, particularly preferably 0.3M or higher, and most preferably 0.04M or higher. The upper limit thereof is preferably 0.8M or lower, more preferably 0.6M or lower, and particularly preferably 0.4M or lower.

### [Manufacture of the Nonaqueous Electrolytic Solution]

The nonaqueous electrolytic solution of the present invention can be obtained, for example, by mixing the above nonaqueous solvent with a tertiary carboxylic acid ester represented by the above general formula (I), and adding the above electrolyte salt thereto.

At this time, for the nonaqueous solvent and the compounds added to the nonaqueous electrolytic solution, the one with minimal impurities purified in advance to an extent where productivity is not significantly lowered should preferably be used.

The energy storage device of the present invention can be obtained, for example, by being provided with a positive electrode, a negative electrode and the above nonaqueous electrolytic solution.

The nonaqueous electrolytic solution of the present invention can be used for the following first to fourth energy storage devices; and as the nonaqueous electrolyte, there can be used one not only in a liquid state but also in a gel state. Further, the nonaqueous electrolytic solution of the present invention can be used for a solid polymer electrolyte. The nonaqueous electrolytic solution is preferably used particularly for the first energy storage device (that is, for a lithium battery) or the fourth energy storage device (that is, for a lithium ion capacitor), which uses lithium salts as the electrolyte salts, more preferably used for a lithium battery, and still more preferably used for a lithium secondary battery.

### [First Energy Storage Device (Lithium Battery)]

In the present description, the term “lithium battery” serving as the first energy storage device is a general term for lithium primary batteries and lithium secondary batteries. Further, in the present description, the term “lithium secondary battery” is used as a concept also including so-called lithium ion secondary batteries. The lithium battery of the present invention includes a positive electrode, a negative electrode, and the nonaqueous electrolytic solution having the electrolyte salt dissolved in the nonaqueous solvent. Except the nonaqueous electrolytic solution, any constituent member may be used for the positive electrode, negative electrode and the like without particular limitations.

For example, as a positive electrode active material for a lithium secondary battery, there is used a complex metal oxide with lithium containing one or more kinds selected from the group consisting of cobalt, manganese and nickel. These positive electrode active materials can be used singly by one kind or in combination of two or more kinds.

As such a lithium complex metal oxide, there is preferably used a compound having a charge potential of the positive electrode in a full-charge state of 4.5 V or higher on Li basis; and as such a compound, there can suitably be used at least one kind of lithium complex metal oxides selected from the group consisting of, for example, LiNi_{0.5}Mn_{1.5}O₄, LiNi_{0.5}Co_{0.2}Mn_{0.3}O₂ and solid solution of Li₂MnO₃ and LiMO₂ (M is a transitional metal such as Co, Ni, Mn and Fe), and the like; and lithium complex metal oxides represented by the following general formula (III) or (IV) are more suitable.

Here, in the present description, the charge potential in a full-charge state means a highest potential (potential on Li basis) of charge potentials at which charge and discharge can be judged to be substantially allowed. The charge potential in a full-charge state specifically means a highest potential (potential on Li basis) of potentials at which lithium is allowed to be reversibly absorbed and released, and more specifically means a highest potential (potential on Li basis) of potentials at which charge and discharge are allowed at a charge and discharge efficiency (charge and discharge efficiency from which there has been excluded the influence of side reactions such as decomposition of the nonaqueous electrolytic solution) of 80% or higher.

LiₐNiₓMn_{y}Co_{z}MₚO₂ (III)

wherein 0<a<1.2, x+y+z+p=1, x>0, y>0, z≧0, p≧0; and M is one or more kinds of elements selected from the group consisting of Mg, Al, B, Ti, V, Nb, Cu, Zn, Mo, Ca, Sr, W and Zr.

LiₐNiₓMn_{2-x-y}M_{y}O₄ (IV)

wherein 0<a<1.2, 0.4≦x≦0.6, y≧0, x+y<2; and M is one or more kinds of elements selected from the group consisting of Mg, Al, B, Ti, V, Nb, Cu, Zn, Mo, Ca, Sr, W and Zr.

Although when a lithium complex metal oxide operating at a high charge voltage is used, there are easily deteriorated the electrochemical properties due to the reaction with an electrolytic solution when it is charged particularly in the case of the use in a broad temperature range, in a lithium secondary battery according to the present invention, the deterioration of these electrochemical properties can be suppressed. Particularly in the case of a positive electrode containing Mn, although since the resistance of a battery tends to be easily increased due to elution of Mn ions from the positive electrode, the electrochemical properties in the case of the use in a broad temperature range tend to be easily deteriorated, in a lithium secondary battery according to the present invention, the deterioration of these electrochemical properties can be suppressed, which is thus preferable.

Further there may be mixed and concurrently used one or two or more kinds selected from LiCoO₂, LiMn₂O₄, LiNiO₂, LiCo₁₋ₓNiₓO₂ (0.01<x<1) and LiCo_{0.98}Mg_{0.02}O₂ with the above-described lithium complex metal oxide which is capable of being used at a charge potential of the positive electrode in a full-charge state of 4.5 V or higher on Li basis.

Further, as the positive electrode active material, a lithium-containing olivine-type phosphoric acid salt can also be mixed and concurrently used. Lithium-containing olivine-type phosphoric acid salts containing particularly one or two or more kinds selected from iron, cobalt, nickel and manganese are preferable. Specific examples thereof include one or two or more kinds selected from LiFePO₄, LiCoPO₄, LiNiPO₄ and LiMnPO₄. Part of the lithium-containing olivine-type phosphoric acid salts may be substituted by other elements. Part of iron, cobalt, nickel and manganese can be substituted by one or two or more kinds of elements selected from Co, Mn, Ni, Mg, Al, B, Ti, V, Nb, Cu, Zn, Mo, Ca, Sr, W and Zr, or the lithium-containing olivine-type phosphoric acid salts can also be coated with a compound containing these other elements or a carbon material. Among these, LiFePO₄ or LiMnPO₄ are preferable.

As for a positive electrode of a lithium primary battery, an oxide of one or two or more kinds of metal elements such as CuO, Cu₂O, Ag₂O, Ag₂CrO₄, CuS, CuSO₄, TiO₂, TiS₂, SiO₂, SnO, V₂O₅, V₆O₁₂, VOₓ, Nb₂O₅, Bi₂O₃, Bi₂Pb₂O₅, Sb₂O₃, CrO₃, Cr₂O₃, MoO₃, WO₃, SeO₂, MnO₂, Mn₂O₃, Fe₂O₃, FeO, Fe₃O₄, Ni₂O₃, NiO, CoO₃, or CoO, a chalcogen compound, sulfur compounds such as SO₂ and SOCl₂, and fluorocarbon (graphite fluoride) or the like represented by a general formula (CFₓ)ₙ can be mentioned. Among the above, MnO₂, V₂O₅, and graphite fluoride, etc., are preferable.

The pH of the supernatant solution when 10 g of the above-mentioned positive electrode active material is dispersed in 100 ml of distilled water is preferably 10.0 to 12.5 since the effect of improving the electrochemical properties at further broad temperature range can be easily obtained, and further preferably 10.5 to 12.0.

Further, the positive electrode preferably contains Ni as an element since impurities such as LiOH in the positive electrode active material tends to increase, and thus the effect of improving the electrochemical properties at further broad temperature range can be easily obtained. The atomic concentration of Ni in the positive electrode active material is further preferably 5 to 25 atomic %, and particularly preferably 8 to 21 atomic %.

The conductive material of the positive electrode is not particularly limited as long as it is an electron conductive material that does not cause chemical change. For example, graphites such as natural graphite (flattened graphite etc.) and artificial graphite, one or two or more kinds of carbon blacks selected from acetylene black, Ketjen black, channel black, furnace black, lamp black and thermal black, etc. may be mentioned. In addition, the graphite and the carbon black may be accordingly mixed and used. The addition amount of the conductive material to the positive electrode mixture is preferably 1% to 10% by mass, and particularly preferably 2% to 5% by mass.

The positive electrode can be manufactured by mixing the above-mentioned positive electrode active material with the conductive material such as acetylene black and carbon black, and a binder such as polytetrafluoroethylene (PTFE), polyvinylidene fluoride (PVDF), a copolymer of styrene and butadiene (SBR), a copolymer of acrylonitrile and butadiene (NBR), carboxymethyl cellulose (CMC), or ethylene-propylene-diene terpolymer, and adding thereto a high boiling-point solvent such as 1-methyl-2-pyrrolidone, and kneading them to prepare the positive electrode mixture, and then applying this positive electrode mixture to a current collector such as aluminum foil and lath plate made of stainless-steel, drying, pressure molding, and then subjecting the resultant to heat treatment at a temperature of about 50° C. to 250° C. for about 2 hours under vacuum.

The density of parts excluding the current collector of the positive electrode is ordinarily 1.5 g/cm³ or more, preferably 2 g/cm³ or more, more preferably 3 g/cm³ or more, and further preferably 3.6 g/cm³ or more in order to further enhance the capacity of the battery. Meanwhile, the upper limit is preferably 4 g/cm³ or less.

As for the negative electrode active material for a lithium secondary battery, lithium metal, lithium alloy, and a carbon material capable of absorbing and releasing lithium (graphitizable carbon, non-graphitizable carbon having 0.37 nm or more of the spacing of the (002) plane, graphite having 0.34 nm or less of the spacing of the (002) plane, etc.], tin (simple substance), a tin compound, silicon (simple substance), a silicon compound and a lithium titanate compound such as Li₄Ti₅O₁₂ can be used alone in one kind or in combination of two or more kinds.

Among the negative electrode active materials, considering absorbance and releasing ability with respect to lithium ions, high-crystalline carbon material such as artificial graphite, natural graphite, or the like is more preferably used, and further preferably, carbon material having a graphite crystal structure where a space (d₀₀₂) between lattice planes (002) is 0.340 nm (nanometer) or less and particularly 0.335 to 0.337 nm is used. Particularly, an artificial graphite particle having a blocky structure where a plurality of flat graphite fine particles are non-parallelly assembled or bonded and a particle obtained by performing spheroidization processing to a scale-like natural graphite by repeatedly applying mechanical actions such as compressive force, frictional force, and shear force are preferably used.

A ratio between a peak intensity I(110) of a (110) plane of a graphite crystal obtained by X-ray diffractometry of a negative electrode sheet where density of parts excluding a current collector of the negative electrode is set to 1.5 g/cm³ or more by press molding and a peak intensity I(004) of a (004) plane, which is I(110)/I(004), is preferably 0.01 or more as electrochemical properties at a broad temperature range can be enhanced even further, more preferably 0.05 or more, and further preferably 0.1 or more. Also, the upper limit for the peak intensity ratio I(110)/I(004), is preferably 0.5 or less, and more preferably 0.3 or less since crystallinity may decrease due to excessive processing and discharge capacity of a battery may decrease.

Additionally, high crystalline carbon material (core material) is preferably coated with carbon material with low crystallinity than the core material as electrochemical properties at a broad temperature range become even better. Crystallinity of the coating carbon material can be confirmed with TEM.

When carbon material with high crystallinity is used, electrochemical properties at low temperature or high temperature tend to decrease by an increase of interfacial resistance due to reaction with the nonaqueous electrolytic solution during charge, however, in the lithium secondary battery according to the present invention, electrochemical properties at a broad temperature range become excellent.

As for a metal compound capable of absorbing and releasing lithium as a negative electrode material, a compound containing at least one kind of metal element such as Si, Ge, Sn, Pb, P, Sb, Bi, Al, Ga, In, Ti, Mn, Fe, Co, Ni, Cu, Zn, Ag, Mg, Sr, and Ba, etc., may be suitably mentioned. Such metal compounds may be used singly or in any other form such as alloy, oxide, nitride, sulfide, boride, or alloy with lithium. However, the one in single use, alloy, oxide, or alloy with lithium is preferable as the capacity can be increased. In particular, the one containing at least one kind of element selected from Si, Ge, and Sn is preferable and the one containing at least one kind of element selected from Si and Sn is more preferable as the capacity of a battery can be increased.

The negative electrode can be manufactured by kneading using the same conductive material, binder, and high boiling-point solvent as used in manufacturing of the positive electrode prepared as a negative electrode mixture, then applying this negative electrode mixture to a copper foil or the like of the current collector, drying, pressure molding, and then subjecting the resultant to heat treatment at a temperature of about 50° C. to 250° C. for about 2 hours under vacuum.

The density of parts other than the current collector of the negative electrode is generally 1.1 g/cm³ or more, and preferably 1.5 g/cm³ or more and more preferably 1.7 g/cm³ or more to further raise the battery capacity. The upper limit thereof is preferably 2 g/cm³ or less.

As a negative electrode active material for a lithium primary battery, lithium metal or lithium alloy can be mentioned.

The separator for the battery is not particularly limited, but a unilamellar or laminated microporous film of a polyolefin such as polypropylene, polyethylene, an ethylene-propylene copolymer, a woven fabric cloth, or a nonwoven fabric cloth, etc. may be used. As for lamination of polyolefin, it is preferable to laminate polyethylene and polypropylene, and particularly a triple-layer structure of polypropylene/polyethylene/polypropylene is more preferable.

The thickness of the separator is preferably 2 μm or more, more preferably 3 μm or more, and further preferably 4 μm. The upper limit thereof is 30 μm or less, preferably 20 μm or less, and more preferably 15 m or less.

To one surface or both surfaces of the separator, a heat-resistant layer including an inorganic particle and/or organic particle and a binder is preferably arranged. The thickness of the heat-resistant layer is preferably 0.5 μm or more, more preferably 1 μm or more, and further preferably 1.5 μm or more. Also, the upper limit thereof is 7 μm or less, preferably 6 μm or less, and more preferably 5 μm or less.

As for an inorganic particle contained in the heat-resistant layer, an oxide containing an element selected from Al, Si, Ti, and Zr or a hydroxide may be suitably mentioned.

As specific examples of the inorganic particle, one or more kinds selected from oxides of silica (SiO₂), alumina (Al₂O₃), titania (TiO₂), zirconia (ZrO₂), or BaTiO₃, etc., and hydroxides such as boehmite (Al₂O₃.3H₂O), etc., can be suitably mentioned, and two or more kinds are more preferable. Among the above, one or more kinds selected from a group consisting of silica (SiO₂), alumina (Al₂O₃), zirconia (ZrO₂), BaTiO₃, and boehmite (Al₂O₃.3H₂O) are preferable, silica (SiO₂), alumina (Al₂O₃), BaTiO₃, and boehmite (Al₂O₃.3H₂O) are more preferable, and alumina (Al₂O₃), BaTiO₃, and boehmite (Al₂O₃.3H₂O) are particularly preferable.

As an organic particle contained in the heat-resistant layer, one or more kinds selected from high-polymer particles such as polyamide, aramid, and polyimide can be suitably mentioned, and two or more kinds are more preferable. In particular, one or more kinds selected from a group consisting of polyamide, aramid, and polyimide are preferable, and polyamide and aramid are more preferable.

As a binder included in the heat-resistant layer, one or more kinds selected from a group consisting of ethylene-vinyl acetate copolymer (EVA), ethylene-acrylic acid copolymer such as ethylene-ethylacrylate copolymer, polytetrafluoroethylene (PTFE), polyvinylidene fluoride (PVDF), fluorine rubber, styrene-butadiene rubber (SBR), carboxymethyl cellulose (CMC), hydroxyethyl cellulose (HEC), polyvinyl alcohol (PVA), polyvinyl butyral (PVB), polyvinyl pyrrolidone (PVP), poly N-vinyl acetamide, crosslinked acrylic resin, polyurethane, and epoxy resin can be suitably mentioned, and two or more kinds are more preferable Among the above, one or more kinds selected from a group consisting of ethylene-acrylic acid copolymer such as ethylene-ethylacrylate copolymer or the like, polyvinyl pyrrolidone (PVP), poly N-vinyl acetamide, polyvinylidene fluoride (PVDF), styrene butadiene copolymer (SBR), and carboxymethyl cellulose (CMC) are preferable.

The structure of the lithium battery is not particularly limited, and the structure of a coin-type battery, a cylinder-type battery, a square-shaped battery, or a laminate-type battery, etc., can be applied.

The lithium secondary battery according to the present invention is excellent in the electrochemical properties at a broad temperature range even when the charge termination voltage is 4.2 V or more, and particularly when 4.3 V or more. Also, the properties are favorable even when the charge termination voltage is 4.4 V or more. The discharge termination voltage is usually 2.8 V or more, and further can be set to 2.5 V or more. However, for the lithium secondary battery according to the present invention, a discharge termination voltage of 2.0V or more can be used. The current value is not particularly limited, but usually a value within a range of 0.1 to 30 C is used. Further, the lithium battery according to the present invention can be charged and discharged at −40 to 100° C., and preferably at −10 to 80° C.

In the present invention, as a countermeasure for a rise of the inner pressure of the lithium battery, a method of arranging a safety valve to a cover of the battery or making incision on a member such as a battery can or gasket may be also adopted. Further, as a safety countermeasure for preventing overcharge, current shutoff mechanism that shuts off the current upon perception of the inner pressure of the battery may be arranged on the cover of the battery.

### [Second Energy Storage Device (Electrical Double-Layer Capacitor)]

The second energy storage device of the present invention contains the nonaqueous electrolytic solution of the present invention, and is an energy storage device for storing energy using electrical double-layer capacity at the interface of the electrolytic solution and electrode. An example of the present invention is an electrical double-layer capacitor. The most typical electrode active material used in the energy storage device is activated carbon. Generally, the double-layer capacity increases proportionally to the surface area.

### [Third Energy Storage Device]

The third energy storage device of the present invention contains the nonaqueous electrolytic solution of the present invention, and is an energy storage device storing energy using dope/de-dope reaction of an electrode. As for an electrode active material used in the energy storage device, a metal oxide such as ruthenium oxide, iridium oxide, tungsten oxide, molybdenum oxide, copper oxide, etc., and a it conjugated polymer such as polyacene, polythiophene derivative, etc., can be mentioned. A capacitor that utilizes these electrode active materials can store energy involved by dope/de-dope reaction of the electrode.

### [Fourth Energy Storage Device (Lithium Ion Capacitor)]

The fourth energy storage device of the present invention contains the nonaqueous electrolytic solution of the present invention, and is an energy storage device that stores energy using intercalation of lithium ions to carbon material such as graphite, which is a negative electrode. The fourth energy storage device is called as lithium ion capacitor (LIC). As for the positive electrode, for example, the one using an electrical double layer between an activated carbon electrode and electrolytic solution, and the one using dope/de-dope reaction of a π conjugated polymer electrode, and the like can be mentioned. To the electrolytic solution, at least lithium salt such as LiPF₆ is contained.

### EXAMPLES

### Examples 1 to 13 and Comparative Example 1

[Manufacturing of Lithium Ion Secondary Battery]94% by mass of LiNi_{0.5}CO_{0.2}Mn_{0.3}O₂ and 3% by mass of an acetylene black (conductive agent) were mixed with each other and then added to and mixed with a solution prepared in advance by dissolving 3% by mass of a polyvinylidene fluoride (a binder) in 1-methyl-2-pyrrolidone to thereby prepare a positive electrode mixture paste. The positive electrode mixture paste was applied to one surface on an aluminum foil (current collector), dried, subjected to a pressing treatment, and then cut to a predetermined size to thereby manufacture a belt-like positive electrode sheet. The density of the part of the positive electrode excluding the current collector was 3.6 g/cm³. Further, 90% by mass of an artificial graphite (d₀₀₂=0.335 nm, a negative electrode active material) and 5% by mass of an acetylene black (conductive agent) were mixed and then added and mixed in a solution prepared in advance by dissolving 5% by mass of a polyvinylidene fluoride (a binder) in 1-methyl-2-pyrrolidone to thereby prepare a negative electrode mixture paste. The negative electrode mixture paste was applied to one surface on a copper foil (current collector), dried, subjected to a pressing treatment, and cut into a predetermined size to thereby manufacture a negative electrode sheet. The density of the part of the negative electrode excluding the current collector was 1.5 g/cm³. Further, from the result of X-ray diffractometry using the electrode sheet, the ratio of a peak intensity I(110) of the (110) plane of the graphite crystal to a peak intensity I(004) of the (004) plane thereof, that is [I(110)/I(004)], was 0.1.

A heat-resistant layer (3 μm) having boehmite particles and an ethylene-vinyl acetate copolymer was formed on both surfaces of a laminated microporous film composed of a triple-layer structure of polypropylene (3 μm)/polyethylene (5 μm)/polypropylene (3 μm) to thereby manufacture a separator having total thickness of 17 μm.

The positive electrode sheet, the separator and the negative electrode sheet obtained in the above were laminated in order, and by adding nonaqueous electrolytic solutions having compositions described in Table 1 and Table 2, respectively, laminate-type batteries were manufactured.

[Discharge Capacity Retention Rate after High Temperature Charge and Storage]

### <Initial Discharge Capacity>

Using the laminate-type battery manufactured by the above-mentioned method, in a 25° C. constant-temperature bath, the laminate-type battery was charged for 3 hours at a 1C-constant current and a constant voltage up to a termination voltage of 4.6 V (a voltage at which the potential of the positive electrode in a full-charge state became 4.5 V on Li basis), and then discharged at a 1C-constant current down to a cut-off voltage of 2.75 V to thereby determine an initial discharge capacity.

### <Test for High Temperature Charge and Storage>

Next, in a 60° C. constant-temperature bath, the laminate-type battery was charged for 3 hours at a 1C-constant current and a constant voltage up to a termination voltage of 4.6 V, and stored for 3 days in the state being held at 4.6 V. Thereafter, the laminate-type battery was put into a 25° C. constant-temperature bath, and once discharged at a 1C-constant current down to a cut-off voltage of 2.75 V.

<Discharge Capacity after High Temperature Charge and Storage>

Further thereafter, as in the measurement of the initial discharge capacity, the discharge capacity after high temperature charge and storage was determined.

<Capacity Retention Rate after High Temperature Charge and Storage>

The capacity retention rate after high temperature charge and storage was determined by the following expression.

Discharge capacity retention rate after high temperature charge and storage (%)=(discharge capacity after high temperature charge and storage/initial discharge capacity)×100.

[Evaluation of Amount of Gas Generated after High Temperature Charge and Storage]

The amount of gas generated after high temperature charge and storage was measured by an Archimedes method. The amount of gas generated was examined as a relative amount of gas generated with the amount of gas generated of Comparative Example 1 taken to be 100% as a basis.

Further, the condition of manufacturing the batteries and the battery properties are shown in Table 1 and Table 2.

TABLE 1

| | | | | Discharge capacity | |
|---|---|---|---|---|---|
| | | | | retention rate | Gas generation |
| | Composition of electrolyte salt | | | after | amount after |
| | Composition of nonaqueous electrolytic | | Another additive | high temperature | high temperature |
| | solution | Compound (I) | Compound (% by | storage | storage |
| | (volume ratio of solvent) | Kind | mass) | (%) | (%) |
| Example 1 | 1M LiPF6 FEC/DMC/Compound (I) (40/30/30) | 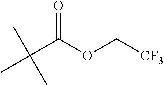 | — | 68 | 74 |
| Example 2 | 1M LiPF6 | | | 71 | 68 |
| | FEC/EC/MTFEC/Compound (I) | | | | |
| | (20/20/55/5) | | | | |
| Example 3 | 1M LiPF6 | | | 73 | 64 |
| | FEC/EC/MTFEC/Compound (I) | | | | |
| | (20/20/45/15) | | | | |
| Example 4 | 1M LiPF6 | | | 77 | 61 |
| | FEC/EC/MTFEC/Compound (I) | | | | |
| | (20/20/30/30) | | | | |
| Example 5 | 1M LiPF6 | | | 76 | 60 |
| | FEC/EC/MTFEC/Compound (I) | | | | |
| | (20/20/20/40) | | | | |
| Example 6 | 1M LiPF6 | | | 79 | 65 |
| | FEC/EC/GBL/MTFEC/Compound (I) | | | | |
| | (20/10/10/30/30) | | | | |
| Example 7 | 1M LiPF6 + 0.1M LiPO2F2 | | adiponitrile (10) | 80 | 57 |
| | FEC/EC/EEC/MTFEC/Compound (I) | | | | |
| | (20/19/1/30/30) | | | | |
| Example 8 | 1M LiPF6 + 0.1M LES | | 2-propynyl | 83 | 55 |
| | FEC/EC/EEC/MTFEC/COMpOUnd (I) | | methanesulfonate (1) | | |
| | (20/19/1/30/30) | | | | |
| Example 9 | 1M LiPF6 + 0.1M LiTFOP | | 1,3 propanesultone | 81 | 58 |
| | FEC/EC/EEC/MTFEC/Compound (I) | | (1) | | |
| | (20/19/1/30/30) | | | | |
| Comparative | 1M LiPF6 | — | — | 59 | 100 |
| Example 1 | FEC/DMC | | | | |
| | (40/60) | | | | |

TABLE 2

| | | | Discharge capacity | |
|---|---|---|---|---|
| | | | retention rate | Gas generation |
| | Composition of electrolyte salt | | after | amount after |
| | Composition of nonaqueous electrolytic | | high temperature | high temperature |
| | solution | Compound (I) | storage | storage |
| | (volume ratio of solvent) | Kind | (%) | (%) |
| Example 10 | 1M LiPF6 FEC/EC/MTFEC/Compound (I) (20/20/45/15) | 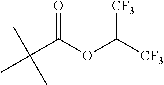 [SMILES: CC(C)(C)C(=O)OC(C(F)(F)F)C(F)(F)F] | 68 | 72 |
| Example 11 | 1M LiPF6 FEC/EC/MTFEC/Compound (I) (20/20/45/15) | 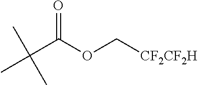 | 69 | 70 |
| Example 12 | 1M LiPF6 FEC/EC/MTFEC/Compound (I) (20/20/45/15) | 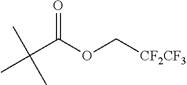 | 72 | 66 |
| Example 13 | 1M LiPF6 FEC/EC/MTFEC/Compound (I) (20/20/45/15) | 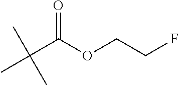 | 65 | 75 |

### Example 14 and Comparative Example 2

Positive electrode sheets were manufactured by using LiNi_{0.5}Mn_{1.5}O₄ (a positive electrode active material) in place of the positive electrode active material used in Example 1 and Comparative Example 1. 94% by mass of the amorphous carbon-coated LiNi_{0.5}Mn_{1.5}O₄ and 3% by mass of an acetylene black (conductive agent) were mixed and then added and mixed in a solution prepared in advance by mixing 3% by mass of a polyvinylidene fluoride (a binder) in 1-methyl-2-pyrrolidone to thereby prepare a positive electrode mixture paste. Laminate-type batteries were manufactured as in Example 1 and Comparative Example 1, except for that the positive electrode mixture paste was applied to one surface on an aluminum foil (current collector), dried, subjected to a pressing treatment, and then cut to a predetermined size to thereby manufacture the positive electrode sheet, that in evaluations for the battery, the charge termination voltage was altered to 4.9 V (a voltage at which the potential of the positive electrode in a full-charge state became 4.8 V on Li basis), and the discharge cut-off voltage was altered to 2.7 V, and that the compositions of the nonaqueous electrolytic solutions were altered to predetermined ones. Then, evaluations for the battery were performed. The results are shown in Table 3.

TABLE 3

| | | | Discharge | |
|---|---|---|---|---|
| | | | capacity retention | Gas generation |
| | Composition of electrolyte salt | | rate after high | amount after |
| | Composition of nonaqueous | | temperature | high temperature |
| | electrolytic solution | Compound (I) | storage | storage |
| | (volume ratio of solvent) | Kind | (%) | (%) |
| Example 14 | 1M LiPF6 FEC/EC/MTFEC/Compound (I) (20/20/30/30) | 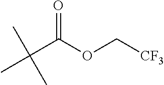 | 69 | 63 |
| Comparative | 1M LiPF6 | — | 55 | 100 |
| Example 2 | FEC/DMC | | | |
| | (40/60) | | | |

### Example 15 and Comparative Example 3

Negative electrode sheets were manufactured by using lithium titanate Li₄Ti₅O₁₂ (a negative electrode active material) in place of the negative electrode active material used in Example 1. 80% by mass of the lithium titanate Li₄Ti₅O₁₂ and 15% by mass of an acetylene black (conductive agent) were mixed and then added and mixed in a solution prepared in advance by mixing 5% by mass of a polyvinylidene fluoride (a binder) in 1-methyl-2-pyrrolidone to thereby prepare a negative electrode mixture paste. Laminated batteries were manufactured as in Example 1, except for that the negative electrode mixture paste was applied to a copper foil (current collector), dried, subjected to a pressing treatment, and then cut to a predetermined size to thereby manufacture the negative electrode sheet, that in evaluations for the battery, the charge termination voltage was altered to 2.8 V, and the discharge cut-off voltage was altered to 1.2 V, and that the compositions of the nonaqueous electrolytic solutions were altered to predetermined ones. Then, evaluations for the battery were performed. The results are shown in Table 4.

TABLE 4

| | | | Discharge capacity | |
|---|---|---|---|---|
| | | | retention rate | Gas generation |
| | Composition of electrolyte salt | | after | amount after |
| | Composition of nonaqueous | | high temperature | high temperature |
| | electrolytic solution | Compound (I) | storage | storage |
| | (volume ratio of solvent) | Kind | (%) | (%) |
| Example 15 | 1M LiPF6 FEC/EC/MTFEC/Compound (I) (20/20/30/30) | 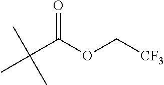 | 85 | 55 |
| Comparative | 1M LiPF6 | — | 76 | 100 |
| Example 3 | FEC/DMC | | | |
| | (40/60) | | | |

Any of the above lithium secondary batteries of Examples 1 to 13 were improved in the high-temperature storage properties at high temperatures as compared with the lithium secondary battery of Comparative Example 1, which was the case where no tertiary carboxylic acid ester represented by the general formula (I) was added in the nonaqueous electrolytic solution of the present invention. Further the same effect was shown also in the cases of using the LiNi_{0.5}Mn_{1.5}O₄ for the positive electrode in comparison of Example 14 and Comparative Example 2, and in the cases of using the lithium titanate for the negative electrode in comparison of Example 15 and Comparative Example 3. Therefore, it is clear that the advantageous effect of the present invention is not an effect depending on a specific positive electrode and negative electrode.

From the above, it has been made clear that the effect in the case of using the energy storage device of the present invention at high voltages is an effect peculiar to the case where a nonaqueous electrolytic solution contains a tertiary carboxylic acid ester represented by the general formula (I).

Further the nonaqueous electrolytic solution of the present invention also has the effect of improving the high-temperature storage properties in the case where a lithium primary battery is used at high voltages.

### INDUSTRIAL APPLICABILITY

The energy storage device using the nonaqueous electrolytic solution according to the present invention is useful as an energy storage device such as a lithium secondary battery excellent in the electrochemical properties in the case where the battery is used at high voltages.

1: A nonaqueous electrolytic solution, comprising an electrolyte salt dissolved in a nonaqueous solvent,
wherein
the nonaqueous electrolytic solution comprises at least one tertiary carboxylic acid ester of the following formula (I): 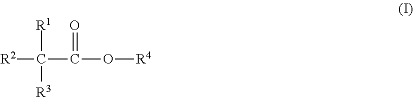
wherein
R¹ to R³ each independently represent a methyl group or an ethyl group; and
R⁴ represents a halogenated alkyl group having 1 to 5 carbon atoms.

2: The nonaqueous electrolytic solution according to claim 1, wherein R⁴ in the formula (I) is a halogenated alkyl group having 2 to 5 carbon atoms in which, among carbon atoms other than a carbon atom bonded directly to an oxygen atom forming an ester group, at least one carbon atom is substituted by at least one halogen atom.

3: The nonaqueous electrolytic solution according to claim 1, wherein the tertiary carboxylic acid ester of formula (I) is at least one selected from the group consisting of fluoromethyl pivalate, difluoromethyl pivalate, 2-chloroethyl pivalate, 2-fluoroethyl pivalate, 2,2-difluoroethyl pivalate, 2,2,2-trifluoroethyl pivalate, 3-fluoropropyl pivalate, 3-chloropropyl pivalate, 3,3-difluoropropyl pivalate, 3,3,3-trifluoropropyl pivalate, 2,2,3,3-tetrafluoropropyl pivalate, 2,2,3,3,3-pentafluoropropyl pivalate, 1,1,1,3,3,3-hexafluoro-2-propyl pivalate, 2,2,2-trifluoroethyl 2,2-dimethylbutanoate, 2,2,2-trifluoroethyl 2-ethyl-2-methylbutanoate, and 2,2,2-trifluoroethyl 2,2-diethylbutanoate.

4: The nonaqueous electrolytic solution according to claim 1, wherein the nonaqueous solvent comprises a cyclic carbonate and a chain ester selected from the group consisting of a chain carbonate and a chain carboxylic acid ester.

5: The nonaqueous electrolytic solution according to claim 4, wherein the cyclic carbonate is at least one selected from the group consisting of ethylene carbonate, propylene carbonate, 4-fluoro-1,3-dioxolan-2-one, vinylene carbonate, vinyl ethylene carbonate, 2-propynyl 2-oxo-1,3-dioxolane-4-carboxylate and 4-ethynyl-1,3-dioxolan-2-one.

6: The nonaqueous electrolytic solution according to claim 4, wherein
the chain carbonate is:
at least one asymmetrical chain carbonate selected from the group consisting of methyl ethyl carbonate, methyl propyl carbonate, methyl isopropyl carbonate, methyl butyl carbonate and ethyl propyl carbonate;
at least one symmetrical chain carbonate selected from the group consisting of dimethyl carbonate, diethyl carbonate, dipropyl carbonate and dibutyl carbonate; or
at least one selected from the group consisting of fluorinated chain carbonates of the following formula (II): 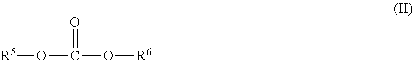
wherein
R⁵ represents a fluorinated alkyl group having 1 to 4 carbon atoms; and
R⁶ represents an alkyl group having 1 to 4 carbon atoms in which at least one hydrogen atom is substituted or not substituted by a fluorine atom, and
the chain carboxylic acid ester is at least one selected from the group consisting of methyl propionate, ethyl propionate, methyl acetate and ethyl acetate.

7: (canceled)

8: The nonaqueous electrolytic solution according to claim 1, comprising, as the electrolyte salt, at least one selected from the group consisting of LiPF₆, LiBF₄, LiN(SO₂CF₃)₂, LiN(SO₂C₂F₅)₂ and LiN(SO₂F)₂.

9: The nonaqueous electrolytic solution according to claim 1, comprising, as the electrolyte salt, at least one selected from the group consisting of a lithium salt having an oxalic acid skeleton, lithium salt having a phosphoric acid skeleton, and lithium salt having an S═O group.

10: The nonaqueous electrolytic solution according to claim 9, wherein the lithium salt having an oxalic acid skeleton is at least one selected from the group consisting of lithium bis(oxalato)borate, lithium difluoro(oxalato)borate, lithium tetrafluoro(oxalato)phosphate, and lithium difluorobis(oxalato)phosphate.

11: The nonaqueous electrolytic solution according to claim 9, wherein the lithium salt having a phosphoric acid skeleton is at least one selected from the group consisting of lithium difluorophosphate and lithium fluorophosphate.

12: The nonaqueous electrolytic solution according to claim 9, wherein the lithium salt having an S═O group is at least one selected from the group consisting of lithium methylsulfate, lithium ethylsulfate, lithium 2,2,2-trifluoroethylsulfate, lithium trifluoro((methanesulfonyl)oxy)borate, lithium pentafluoro((methanesulfonyl)oxy)phosphate and lithium fluorosulfonate.

13: The nonaqueous electrolytic solution according to claim 1, further comprising at least one selected from the group consisting of nitrile compounds, isocyanate compounds, compounds containing a triple bond, cyclic or chain S(═O) group-containing compounds, phosphorus-containing compounds, cyclic acid anhydrides and cyclic phosphazene compounds.

14-15: (canceled)

16: An energy storage device, comprising:
a positive electrode;
a negative electrode;
a separator; and
a nonaqueous electrolytic solution comprising an electrolyte salt dissolved in a nonaqueous solvent,
wherein
the potential of the positive electrode in a full-charge state is 4.5 V or higher with reference to lithium; and
the nonaqueous electrolytic solution comprises at least one tertiary carboxylic acid ester of the following formula (I): 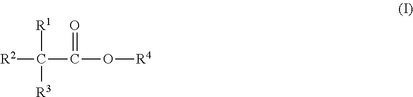
wherein
R¹ to R³ each independently represent a methyl group or an ethyl group; and
R⁴ represents a halogenated alkyl group having 1 to 5 carbon atoms.

17: The energy storage device according to claim 16, wherein an active material of the positive electrode is:
a complex metal oxide comprising lithium and at least one element selected from the group consisting of cobalt, manganese, and nickel; or
a lithium-containing olivine-type phosphate comprising at least one element selected from the group consisting of iron, cobalt, nickel and manganese.

18: The energy storage device according to claim 17, wherein an active material of the negative electrode is selected from the group consisting of lithium metal, lithium alloy, carbon material capable of absorbing and releasing lithium, tin, a tin compound, silicon, a silicon compound, and a lithium titanate compound.

19: The nonaqueous electrolytic solution according to claim 4, wherein a content of the cyclic carbonate to the chain ester in volume ratio (cyclic carbonate:chain ester) is from 10:90 to 45:55.

20: The nonaqueous electrolytic solution according to claim 9, wherein
the lithium salt having an oxalic acid skeleton is at least one selected from the group consisting of lithium bis(oxalato)borate, lithium difluoro(oxalato)borate, lithium tetrafluoro(oxalato)phosphate, and lithium difluorobis(oxalato)phosphate,
the lithium salt having a phosphoric acid skeleton is at least one selected from the group consisting of lithium difluorophosphate and lithium fluorophosphate,
the lithium salt having an S═O group is at least one selected from the group consisting of lithium methylsulfate, lithium ethylsulfate, lithium 2,2,2-trifluoroethylsulfate, lithium trifluoro((methanesulfonyl)oxy)borate, lithium pentafluoro((methanesulfonyl)oxy)phosphate and lithium fluorosulfonate, and
a total content of at least one lithium salt selected from the group consisting of lithium bis(oxalato)borate, lithium difluoro(oxalato)borate, lithium tetrafluoro(oxalato)phosphate, lithium difluorobis(oxalato)phosphate, lithium methylsulfate, lithium ethylsulfate, lithium 2,2,2-trifluoroethyl sulfate, lithium trifluoro((methanesulfonyl)oxy)borate, lithium pentafluoro((methanesulfonyl)oxy)phosphate, lithium fluorosulfonate, lithium methylsulfate, lithium ethylsulfate, lithium 2,2,2-trifluoroethyl sulfate, lithium trifluoro((methanesulfonyl)oxy)borate, lithium pentafluoro((methanesulfonyl)oxy)phosphate and lithium fluorosulfonate is 0.001 to 10% by mass in the nonaqueous electrolytic solution.

21: The nonaqueous electrolytic solution according to claim 1, wherein a content of the tertiary carboxylic acid ester of the formula (I) is 1 to 50% by volume with respect to the total volume of a nonaqueous solvent.

22: The energy storage device according to claim 16, wherein the positive electrode comprises a lithium complex metal oxide of the following formula (III) or (IV):
LiₐNiₓMn_{y}Co_{z}MₚO₂ (III)
wherein
0<a<1.2, x+y+z+p=1, x>0, y>0, z≧0, p≧0; and
M is at least one element selected from the group consisting of Mg, Al, B, Ti, V, Nb, Cu, Zn, Mo, Ca, Sr, W and Zr, and
LiₐNiₓMn_{2-x-y}M_{y}O₄ (IV)
wherein
0<a<1.2, 0.4≦x≦0.6, y≧0, x+y<2; and
M is at least one element selected from the group consisting of Mg, Al, B, Ti, V, Nb, Cu, Zn, Mo, Ca, Sr, W and Zr.

23: The energy storage device according to claim 16, wherein the positive electrode comprises at least one lithium complex metal oxide selected from the group consisting of LiNi_{0.5}Mn_{1.5}O₄, LiNi_{0.5}Co_{0.2}Mn_{0.3}O₂ and solid solution of Li₂MnO₃ and LiMO₂, wherein M is a transitional metal.
